(19) United States
(12) Patent Application Publication
(10) Pub. No.: US 2025/0249648 A1
(43) Pub. Date: Aug. 7, 2025

(54) FIBER REINFORCED PLASTIC COMPONENTS WITH INCREASED SLIP-RESISTANCE AND METHODS OF MANUFACTURE

(71) Applicant: ENDURO COMPOSITES, INC., Houston, TX (US)

(72) Inventor: Wallace S. WOODLIEF, Houston, TX (US)

(21) Appl. No.: 19/188,287

(22) Filed: Apr. 24, 2025

Related U.S. Application Data
(63) Continuation-in-part of application No. 17/563,374, filed on Dec. 28, 2021.
(60) Provisional application No. 63/131,040, filed on Dec. 28, 2020.

(51) Int. Cl. B29C 70/52; B29K 309/08

(52) U.S. Cl. CPC B29C 70/525; B29K 2309/08

(57) ABSTRACT

The present application pertains to components such as tank covers with increased slip resistance and processes for making such components. Generally, a patterned release fabric is employed in a manner such that a formed fiber reinforced plastic component has a textured pattern on at least one surface to increase slip resistance.

### CROSS-REFERENCE TO RELATED APPLICATIONS

The present application is a continuation-in-part of pending U.S. application Ser. No. 17/563,374 filed Dec. 28, 2021 which claims priority to U.S. provisional application Ser. No. 63/131,040 filed Dec. 28, 2020. The aforementioned related applications are incorporated by reference.

### FIELD OF THE INVENTION

This application is related to fiber reinforced plastic components with increased slip resistance for use as, for example, wastewater tank covers and processes for making such components.

### BACKGROUND

Current fiber reinforced plastic components such as tank covers often have a surface that tends to be slippery and not particularly conducive to, for example, humans walking on the surface. It would be desirable if components could be made such as tank covers wherein at least one surface had better resistance to slip.

### SUMMARY OF THE INVENTION

In general, the application pertains to components with increased slip resistance and processes for making such components. In one specific embodiment, the application pertains to a process for making a component with increased slip resistance. The process generally comprises contacting a patterned release fabric with a resin and a reinforcement material under conditions to form a composite component with the patterned release fabric embedded on a side of the composite component. The patterned release fabric is then removed from the composite component under conditions to form a patterned composite component having increased slip resistance.

Further features of the disclosed design, and the advantages offered thereby, are explained in greater detail hereinafter with reference to specific example embodiments.

### BRIEF DESCRIPTION OF THE DRAWINGS

FIG. 1 depicts a representative non-skid surface made using the techniques described herein.

### DETAILED DESCRIPTION

In general, the application pertains to components with increased slip resistance and processes to make such components. While virtually any component may be made using the methods described components that are specifically contemplated include tank covers and other components that may be used as a walking surface for humans or animals. Tank covers and other contemplated components are often used in water and waste water treatment such as, for example, those shown in the examples herein. Such tank covers often have strength for long span capability and high load conditions. The tank cover may be custom designed and configured to accommodate most tanks with different shapes, including but not limited to rectangular or round, and different sizes, including but not limited to small or large. Other potential components that may benefit from the non-slip surface and embodiments described herein include, but are not limited to, moving walkways; standing and walking surfaces used in mass transit such as subway floors and train platforms; water towers and cooling towers; roofing and flooring surfaces, etc. Of course, the technology described herein may also have applicability beyond walking or standing surfaces to essentially any resin based product in need of a roughened, textured surface.

The tank covers usually comprise a fiberglass reinforced plastic cover with a high content of reinforcing fibers (up to 60% by weight). The tank cover may comprise one or more panels configured to be removable over an extended period of time without sacrificing structural integrity to the deck and beams even after repeated use. Advantageously, using the processes described herein the panels may comprise non-skid, high-strength structural panels configured, for example, for worker foot traffic. Any number of the panels may also include a gritted surface. In this manner, the high-strength, pultruded, extruded, or other panels may enable the cover to be used as a safe, working surface for operators. The flat, textured surface protects slippage of the operator and/or maintenance personnel as well as, reduces the likelihood of tripping hazards for operators and/or maintenance personnel.

The process employed for making a component with increased slip resistance varies depending upon the desired slip resistance, the type of component, and the other desired properties of the component to be made. Generally, the process comprises first contacting a patterned release fabric with a resin and a reinforcement material under conditions to form a composite component with release fabric embedded on a side of the composite component.

In some embodiments the present process imparts skid resistance on, for example, molded fiberglass components by employing in situ pultrusion skid resistance. In situ pultrusion advantageously imparts skid resistance in multiple directions. That is, skid resistance is created by pultruding longitudinal grooves in one direction to provide skid resistance in a direction lateral to the groove direction without imparting 360 degree directional skid resistance. Furthermore, the in situ pultrusion process which may be employed here is different than pultruding a surface longitudinal groove component and then post-fabricating by cutting across the longitudinal grooves to create a 360 degree skid resistance. Thus, in some embodiments the processes here employ in situ pultrusion to create a 360 degree skid resistance and use a targeted technical target depth of the profiled surface on a release fabric to meet a targeted surface friction. Patterned Release Fabric

The patterned release fabric is not particularly limited so long as it may be subsequently removed to provide a textured pattern in the component to provide increased slip resistance. In some embodiments the patterned release fabric may be selected based upon the conditions, e.g., temperature and pressure to which it will be subjected. The patterned release fabric may be a woven material with high temperature characteristics such as a glass fabric. Glass and other fabrics that may be subjected to the high temperatures, e.g., higher than about 250, or higher than about 300 F, or higher than about 500 F, employed when using resins such as thermoplastics or thermosets with or without reinforcing material. Useful resins may include, but are not limited to, polyesters, vinyl esters, acrylics, modified acrylics, epoxies, urethanes and polyurethanes, polyolefins, and combinations thereof. If desired the glass fabric may be coated with a release agent to facilitate removal from the formed composite leaving the pattern embedded on the component. Such release agents include, for example, polytetrafluoroethylene (PTFE).

The pattern of the release fabric may be selected such that it imparts the desired anti-slip and other properties to the component when it is removed. In some embodiments the patterned release fabric may be an open mesh pattern. The openings may then allow for softened resin (reinforced or not) to flow through at least a portion of the openings such that the fabric is embedded by a desired depth into the softened component. In this manner when the fabric is removed from the component an anti-slip pattern is left on the component. Such open mesh patterns may comprise the same or different shaped openings of the same or different sizes.

For example, the patterned release fabric is an open mesh pattern such as a plain weave comprising polygonal shaped openings selected from triangles, squares, rectangles, pentagons, hexagons, and combinations thereof. In other embodiments the pattern may comprise spherical, elliptical or other shapes or combinations. In some embodiments the size of the longest dimension of each opening may be from about 1 mm to about 5 mm.

The weight of the patterned release fabric may vary depending upon the desired application and properties. In some embodiments the fabric has a weight configured so that the fabric is embedded into a desired thickness of the composite component at a desired applied pressure. In some embodiments the patterned release fabric has a weight of from about 200 g/m² to about 700 g/m², or from about 400 g/m² to about 600 g/m². Suitable release fabrics may include FF0250W and FF0300W available from Solvay.

### Application and Removal of Release Fabric

The specific manner of applying and releasing the patterned fabric to a composite is not particularly critical so long as a patterned composite component having increased slip resistance is formed. Thus, the fabric may be applied while the component is being formed or manufactured. Thus, if the component is being made via a die or molding process then the release fabric may be applied into the mold or die while the resin (with or without reinforcing material such as glass) is sufficiently soft such that resin and any reinforcing materials may flow at least partially through any openings in the fabric. Similarly, if the component is being made via extrusion, pultrusion or some other continuous process then the fabric may be employed at a suitable location during the process such that it is sufficiently embedded while the component is being formed into the final shape or profile. Once cooled, the fabric is removed in a convenient manner forming the final component with a pattern such that desired texture provides anti-slip properties.

In other embodiments a composite component may already be formed and antislip properties are desired to be added. In such cases if the component is a thermoplastic or other material that may be deformable by heat, then a sufficient amount of heat may be applied and the release fabric is then embedded into the component with or without additional pressure. As described above, once sufficiently cooled then the fabric is removed in a convenient manner forming the final component with a pattern such that desired texture provides anti-slip properties.

If desired the component with anti-slip properties may be subjected to further processes such as painting or coating as desired.

### EXAMPLES

Water and wastewater tank covers or other surfaces in need of a non-skid surface may advantageously be integrally manufactured with a multi-directional, non-skid fiberglass-reinforced polymer surface technology using the above-described techniques. Such covers or other surfaces are an enhancement to applied non-skid tape in regard to durability and/or savings in field labor. The surfaces may often exceed performance requirements per ANSI A 137.1/A 326.3 Dynamic Coefficient of Friction Test and/or A SH B 198:2014 (A S/N ZS 4586) Pendulum Test and/or ASTM D2047.

The increased slip resistance components are not particularly limited. In representative examples, Enduro products known as AXS3, XL3, XL6, and TUFF SPAN may employ the technology as described in Enduro Composites 2020 or 2021 Water and Wastewater Products brochures which are incorporated by reference herein. Suitable cover systems to employ the anti-slip technology described herein are also described in U.S. Ser. No. 17/539,957 filed Dec. 1, 2021 which application is incorporated herein by reference. ANSI A 137.1/A 326.3 Dynamic Coefficient of Friction Test

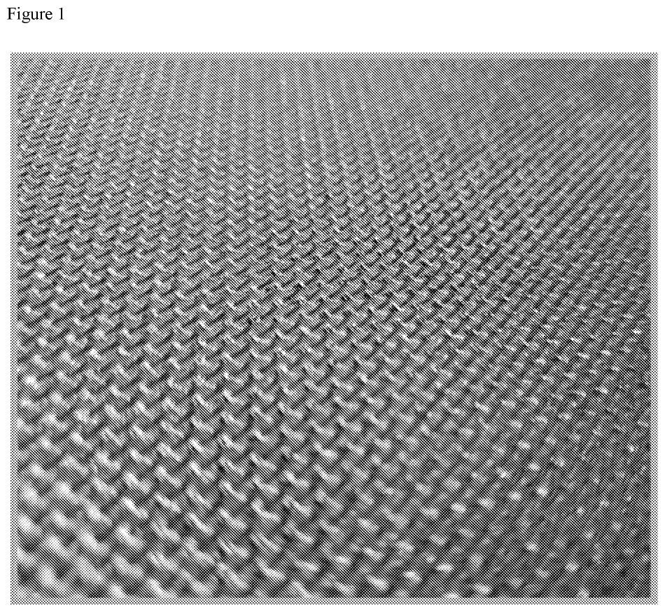

FIG. 1 depicts a representative non-skid surface made using an in-situ pultrusion process as described herein. The sample was tested per ANSI A 137.1/A 326.3 Dynamic Coefficient of Friction Test. The American National Standards Institute (ANSI) published the A 137.1-2012 American National Standard test for measuring dynamic coefficient of friction (DCOF) of common hard-surface indoor level floor materials in 2012. This ANSI standard was incorporated as a requirement in “Section 2103.6 Ceramic Tile” of the 2012 International Building Code published by the International Code Council. (It was removed for the next edition in 2015.) That section states that “Ceramic tile shall be defined in, and shall conform to the requirements of, ANSI A137.1.” ANSI published A 326.3 in 2017, which uses the same test method as A 137.1, but allows for all hard flooring materials to be tested, adds some disclaimers, and describes the method for testing in the field.

A verage Dynamic Coefficient of Friction (DCOF) was tested with BOT-3000E digital tribometer using SBR rubber slider and 0.05% SLS water solution:
Area #1 Wet: 0.57, 0.56, 0.54, 0.57; Avg.=0.56
Area #2 Wet: 0.58, 0.59, 0.57, 0.57; Avg.=0.58
Area #3 Wet: 0.58, 0.58, 0.57, 0.58; Avg.=0.58
Overall average: Wet: 0.57
T=58 degrees F.; Relative humidity=57%;

High dynamic coefficient of friction values indicate potentially good traction. The ANSI A326.3 standard, Section 3.1, states that “Unless otherwise specified, hard surface flooring materials suitable for level interior spaces expected to be walked upon wet with water shall have a wet DCOF of 0.42 or greater when tested using SBR sensor material and SLS solution as per this standard. However, hard surface flooring materials with a DCOF of 0.42 or greater are not necessarily suitable for all projects. The specifier shall determine materials appropriate for specific project conditions, considering by way of example, but not in limitation, “type of use, traffic, expected contaminants, expected maintenance, expected wear, and manufacturers' guidelines and recommendations.

“ . . . The presence on installed hard surface flooring materials of water, oil, grease, and/or any other elements which reduce traction, creates slippery conditions . . . Applications with exposure to such elements require extra caution in product selection, use, and maintenance. . . . When tested using SBR sensor material and SLS solution as per the procedure in this standard, hard surface flooring materials with a wet DCOF of less than 0.42 shall only be installed when the surface will be kept dry when walked upon and proper safety procedures will be followed when cleaning the hard surface flooring materials.”

### AS HB 198:2014 (AS/NZS 4586) Pendulum Test

FIG. 1 depicts a representative non-skid surface made using an in-situ pultrusion process as described herein. The sample was tested per AS HB 198:2014 (AS/NZS 4586) Pendulum Test.

The pendulum is the national standard test device for pedestrian slip resistance in at least 50 nations on five continents and has been endorsed by Ceramic Tile Institute of America since 2001. It has been in continuous use since 1970 for assessing slip resistance of pedestrian surfaces, and is the most widely accepted slip resistance test device worldwide. The trailing edge of a three-inch-wide spring-loaded slider, which is attached to the end of a 20-inch pendulum, contacts the tested surface when the pendulum is released from a horizontal position. The slider contact path length is pre-set to 124-126 mm (approximately 5 inches). The pendulum pushes a pointer that stops and stays at the high point of the pendulum's swing. The hard Four S (“Standard Shoe Sole Simulating”) rubber is generally used for pendulum testing unless the flooring area will be primarily used by barefoot people, in which case the softer TRL rubber may be used. The soft rubber is more representative of bare feet and soft shoe soles, such as is typically found on running shoes.

Pendulum Test Value (PTV), as received of the sample like FIG. 1, with Four S (96) hard rubber slider resulted in values of Dry: 55 Wet: 49. High Pendulum Test Values indicate potentially good traction. AS HB 198:2014 recommends a range of situation-specific minimum Pendulum Test Values as shown in the attached table below. The Ceramic Tile Institute of America (CTIOA) and United Kingdom Slip Resistance Group (UKSRG) make a more general recommendation and say that a minimum pendulum test value of 36 for level floors is considered “low slip potential”. According to CTIOA and UKSRG, values of 25-35 are classed as “moderate slip potential”. Values of 0-24 have “high slip potential”. Slip resistance can be affected by factors such as floor coatings, abrasives, detergents, contamination, chemical treatments, and wear.

### Embodiments

1. A process for making a walkable tank cover with increased slip resistance comprising:
mixing a resin with glass at a ratio of resin to glass of from about 45%, or at least 50%, or at least 55% up to about 60%, or up to about 65%, or up to about 70% or more by weight of the total to form a composite mixture;
pultruding the composite mixture using a heated die while contacting a patterned release fabric with the composite mixture;
curing the composite mixture in situ to form a composite component with the release fabric embedded on a side of the composite component; and
removing the patterned release fabric from the composite component to form a walkable tank cover having increased slip resistance and a stiffness of at least 5,000,000, or at least 7,500,000, or at least about 9,000,000, or at least about 10,000,000 or more up to about 15,000,000, or up to about 12,500,000, or up to about 11,000,000 lb/in² per foot of width.

2. The process of embodiment 1 wherein the patterned release fabric comprises a woven glass fabric.

3. The process of embodiment 1 wherein the resin comprises a polyester, a vinyl ester, an acrylic, a modified acrylic, an epoxy, a urethane, a polyurethane, a polyolefin, or any combination thereof.

4. The process of embodiment 1 wherein the pultrusion is conducted in the absence of a tape or a coating.

5. The process of embodiment 1 which further comprises applying a veil finish or UV protection.

6. The process of embodiment 1 wherein the pultruding comprises forming a panel of from about 2 inches to about 4 inches in thickness.

7. The process of embodiment 1 wherein the patterned release fabric is an open mesh pattern comprising polygonal shaped openings selected from triangles, squares, rectangles, pentagons, hexagons, and combinations thereof.

8. The process of embodiment 1 wherein the patterned release fabric is an open mesh pattern wherein the size of the longest dimension of each opening is from about 1 mm to about 5 mm.

9. The process of embodiment 1 wherein the patterned release fabric is a glass fabric mesh.

10. The process of embodiment 1 wherein the patterned release fabric is coated with a release agent.

11. The process of embodiment 1 wherein the patterned release fabric is coated with polytetrafluoroethylene.

12. The process of embodiment 1 wherein the patterned release fabric has a weight configured so that the fabric is embedded into a desired thickness of the composite component.

13. The process of embodiment 1 wherein the patterned release fabric has a weight of from about 200 g/m² to about 700 g/m².

14. The process of embodiment 1 wherein the patterned release fabric has a weight of from about 400 g/m² to about 600 g/m².

15. The product of the process of any one or more of the preceding claims.

The description of embodiments provides non-limiting representative examples to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A process for making a walkable tank cover with increased slip resistance comprising:
mixing a resin with glass at a ratio of resin to glass of from about 45% to about 70% by weight of the total to form a composite mixture;
pultruding the composite mixture using a heated die while contacting a patterned release fabric with the composite mixture;
curing the composite mixture in situ to form a composite component with the release fabric embedded on a side of the composite component; and
removing the patterned release fabric from the composite component to form a walkable tank cover having increased slip resistance and a stiffness of at least 10,000,000 lb/in² per foot of width.

2. The process of claim 1 wherein the patterned release fabric comprises a woven glass fabric.

3. The process of claim 1 wherein the resin comprises a polyester, a vinyl ester, an acrylic, a modified acrylic, an epoxy, a urethane, a polyurethane, a polyolefin, or any combination thereof.

4. The process of claim 1 wherein the pultrusion is conducted in the absence of a tape or a coating.

5. The process of claim 1 which further comprises applying a veil finish or UV protection.

6. The process of claim 1 wherein the pultruding comprises forming a panel of from about 2 inches to about 4 inches in thickness.

7. The process of claim 1 wherein the patterned release fabric is an open mesh pattern comprising polygonal shaped openings selected from triangles, squares, rectangles, pentagons, hexagons, and combinations thereof.

8. The process of claim 1 wherein the patterned release fabric is an open mesh pattern wherein the size of the longest dimension of each opening is from about 1 mm to about 5 mm.

9. The process of claim 1 wherein the patterned release fabric is a glass fabric mesh.

10. The process of claim 1 wherein the patterned release fabric is coated with a release agent.

11. The process of claim 1 wherein the patterned release fabric is coated with polytetrafluoroethylene.

12. The process of claim 1 wherein the patterned release fabric has a weight configured so that the fabric is embedded into a desired thickness of the composite component.

13. The process of claim 1 wherein the patterned release fabric has a weight of from about 200 g/m² to about 700 g/m².

14. The process of claim 1 wherein the patterned release fabric has a weight of from about 400 g/m² to about 600 g/m².
